(19) United States
(12) Patent Application Publication
(10) Pub. No.: US 2012/0137108 A1
(43) Pub. Date: May 31, 2012

(54) SYSTEMS AND METHODS INTEGRATING BOOLEAN PROCESSING AND MEMORY

(76) Inventor: Kenneth Elmon KOCH, III, Waxhaw, NC (US)

(21) Appl. No.: 13/114,391

(22) Filed: May 24, 2011

Related U.S. Application Data
(63) Continuation-in-part of application No. 12/033,644, filed on Feb. 19, 2008, now abandoned.
Application No. 12/033,644 is a continuation-in-part of application No. 12/364,047, filed on Feb. 2, 2009.

(51) Int. Cl. G06F 9/305

(52) U.S. Cl. 712/200; 712/E09.018

(57) ABSTRACT

The present disclosure relates to placing a Boolean Processor on a chip with memory to eliminate memory latency issues in computing systems. An asynchronous implementation of a Boolean Processor Switched Memory can theoretically operate at terahertz speed and vastly improve the rate at which computationally relevant data is fed to a microprocessor or microcontroller. Boolean Processor Enhanced Memories hold the promise of increasing memory throughput by several orders of magnitude and shifting the burden of “catching up” to microprocessors and microcontrollers.

### CROSS-REFERENCE TO RELATED APPLICATION(S)

The present non-provisional patent application/patent claims the benefit of priority of U.S. Provisional Patent Application No. 61/122,439, filed on Dec. 15, 2008 and entitled “THE BOOLEAN PROCESSOR—NOVEL METHODS AND MACHINES TO ADDRESS DATA LATENCY,” the contents of which are incorporated in full by reference herein. The present non-provisional patent application/patent is a continuation-in-part of co-pending U.S. patent application Ser. No. 12/033,644 filed on Feb. 19, 2008 and entitled “BOOLEAN PROCESSOR” and of co-pending U.S. patent application Ser. No. 12/364,047 filed on Feb. 2, 2009 and entitled “ENHANCED BOOLEAN PROCESSOR,” the contents of each are incorporated in full by reference herein.

### FIELD OF THE INVENTION

The present invention relates generally to the computing and microelectronics field. More particularly, the present invention relates to integration of Boolean Processor circuitry within a memory module and an associated memory switching method.

### BACKGROUND OF THE INVENTION

Conventional microprocessor speeds continue to outpace speeds of associated main memory. As a result, engineers and designers continually evolve designs to minimize latency between data retrieval from memory and data processing by adding fast memory within a processor (i.e., on-chip memory). Sophisticated caching schemes have also been added to processors to help bridge the gap, working under an assumption that most related data resides within a small physical proximity in memory and is reused within a close proximity in time. Even under the best caching conditions, processors waste valuable computing time waiting for data. Processing only gets more difficult as the amount of data is increased and the data becomes increasingly sparse. For example, the processing of large sets of sparse data is required in various applications, such as data indexing, genome processing, weather prediction, and simulations. These large sets of sparse data must be narrowed down and qualified for relevance, typically followed by an arbitrary number of computations on the relevant data. In such exemplary cases, caching provides minimal or no benefit.

### BRIEF SUMMARY OF THE INVENTION

In an exemplary embodiment, an integrated circuit forming a memory module connected to a microprocessor includes a plurality of memory segments configured to store data; a Boolean Processor unit in communication with the plurality of memory segments; and a plurality of input/output interfaces in communication with the plurality of memory segments, the Boolean Processor, and the microprocessor; wherein the Boolean Processor unit is configured to qualify data for the microprocessor from the plurality of memory segments responsive to the instructions. In another exemplary embodiment, a Boolean Processor Switched Memory includes a Boolean Processor receiving instructions from an external device and sending data to the external device based on the instructions; a plurality of memory segments; and memory segment switching circuitry connected to the Boolean Processor and the plurality of memory segments; wherein the Boolean Processor is configured to receive instructions from the external device and transmit data based on the instructions from the plurality of memory segments. In yet another exemplary embodiment, a method includes, a memory module including an integrated Boolean Processor, receiving an instruction related to qualifying data in the memory module; generating a Boolean operation based on the instruction; evaluating the Boolean operation on data in the memory module; and providing qualified data based on the evaluation to an external device from the memory module.

### BRIEF DESCRIPTION OF THE DRAWINGS

The present invention is illustrated and described herein with reference to the various drawings of exemplary embodiments, in which like reference numbers denote like method steps and/or system components, respectively, and in which:

FIG. 1 is a block diagram of the architecture of a Boolean Processor;

FIG. 2 is a diagram of an exemplary Conjunctive Normal Form (CNF) Boolean Processor;

FIG. 3 is a diagram of an exemplary Disjunctive Normal Form (CNF) Boolean Processor;

FIG. 4 is a flowchart of a re-compiling process for use with the present invention;

FIG. 5 is a flowchart of a method for processing a Boolean expression;

FIG. 6 is a flowchart of a method for evaluating a Boolean expression;

FIG. 7 is a flowchart of a compiling method;

FIG. 8 is a flowchart of a method for processing a Boolean expression;

FIG. 9 is a block diagram of a Chip on Memory configuration where a Boolean Processor is integrated within a memory module (RAM);

FIG. 10 is a diagram of an exemplary 2 GB Boolean Processor Switched Memory chip for realizing the Chip on Memory configuration of FIG. 9;

FIG. 11 is the diagram of FIG. 10 illustrating an exemplary operation;

FIG. 12 is a block diagram of a configuration where a Boolean Processor is integrated within a memory module (RAM) with many large blocks of RAM;

FIG. 13 is a flowchart of a method of matching sub-bytes utilizing exemplary embodiments of the present invention; and

FIG. 14 is a flowchart of a method for repetitively matching the contents of one or more bytes utilizing exemplary embodiments of the present invention.

### DETAILED DESCRIPTION OF THE INVENTION

In various exemplary embodiments, a Boolean Processor is capable of evaluating complex Boolean expressions that are in Conjunctive Normal Form (CNF) and/or Disjunctive Normal Form (DNF) Boolean expressions. The short-circuit evaluation of a Boolean expression or operation is simply the abandonment of the remainder of the expression or operation once its value has been determined. If the outcome of the expression or operation can be determined prior to its full evaluation, it makes sense to save processing cycles by avoiding the remaining, unnecessary, conditional tests of the expression or operation. In other words, the short-circuit evaluation of a Boolean expression is a technique that specifies the partial evaluation of the expression involving an AND and/or an OR operation, or a plurality of each.

The Boolean Processor is an original computing architecture which performs the short-circuit evaluation of complex Boolean expressions in Conjunctive Normal Form, Disjunctive Normal Form, or both. Performing the short-circuit evaluations directly in hardware, the Boolean Processor provides a highly scalable and efficient means of computing in environments that are typically suited to microcontroller and microprocessor circuitry.

A Boolean expression is in DNF if it is expressed as the sum (OR) of products (AND). That is, the Boolean expression B is in DNF if it is written as:

A1 OR A2 OR A3 OR . . . An (1)

where each term Ai is expressed as:

T1 AND T2 AND . . . Tm (2)

where each term Ti is either a simple variable, or the negation (NOT) of a simple variable. Each term Ai is referred to as a “minterm”. A Boolean expression is in CNF if it is expressed as the product (AND) of sums (OR). That is, the Boolean expression B is in CNF if it is written as:

O1 AND O2 AND O3 AND . . . On (3)

On where each term Oi is expressed as:

T1 OR T2 OR . . . Tm (4)

where each term Ti is either a simple variable, or the negation (NOT) of a simple variable. Each term O1 is referred to as a “maxterm”. The terms “minterm” and “maxterm” can also be referred to as “disjunct” and “conjunct”, respectively.

The short-circuit evaluations of a CNF Boolean expression and a DNF Boolean expression are handled differently. In the case of a CNF expression, short-circuiting can occur if any of the conjuncts evaluates to false. In the following example,

(AVB)̂(CVD) (5)

if either of the conjuncts, (A V B) or (C V D), evaluates to false, the expression also evaluates to false. If (A V B) evaluates to false, the remainder of the expression can be eliminated, thereby saving the time required to evaluate the other conjunct. In contrast to CNF short-circuit evaluation, a DNF expression can be short-circuited if any of the disjuncts evaluates to true. Using the previous example in DNF,

(ÂC)V(ÂD)V(B̂C)V(B̂D) (6)

if any of the disjuncts, (ÂC), (ÂD), (B̂C), or (B̂D), evaluates to true, the expression also evaluates to true. For example, if (ÂC) evaluates to true, the evaluation of the remaining three disjuncts can be eliminated, since their values are irrelevant to the outcome of the expression.

Thus, the short-circuit evaluation of both CNF and DNF expressions becomes increasingly valuable, in terms of cycle savings, as the complexity of the expressions increases. In large scale monitoring and automation applications, the short-circuit evaluation of both CNF and DNF expressions is essential.

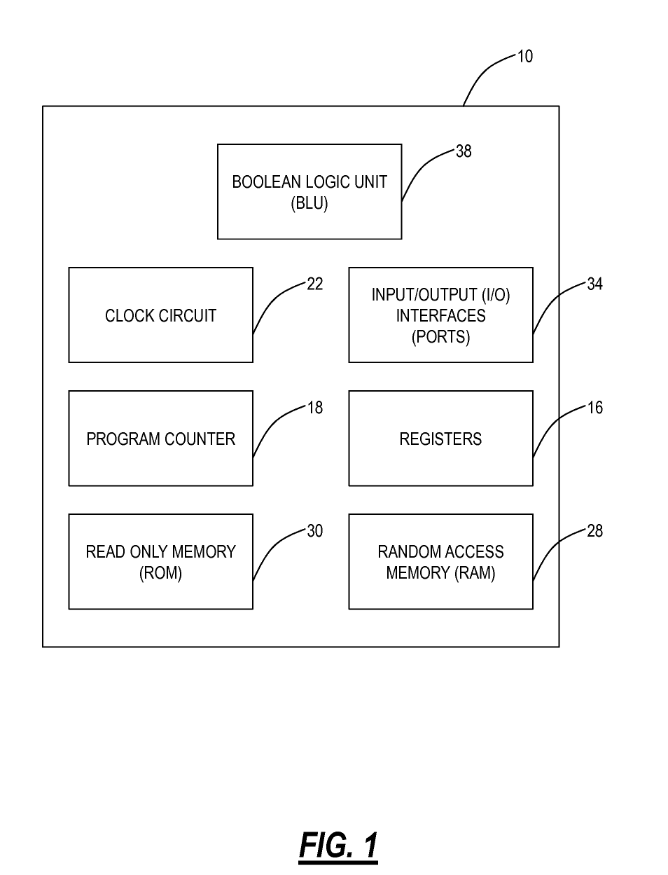

Referring to FIG. 1, in an exemplary embodiment, the architecture of a Boolean Processor 10 can best be described as that of a microcontroller, at least functionally. The inputs of the microcontroller are compiled Boolean operations, or tests, and the outputs of the microcontroller are compiled result operations that are executed in conjunction with the results of the tests. The Boolean Processor 10 includes a plurality of registers 16, a program counter 18, a clock circuit 22, a random-access memory (RAM) 28, a read-only memory (ROM) 30, and a plurality of Input/Output (I/O) interfaces (ports) 34. The Boolean Processor 10 differs, however, from a conventional microcontroller in that the Boolean Processor 10 does not contain an accumulator, a plurality of counters (other than the program counter 18), a plurality of interrupt circuits, or a stack pointer. Additionally, in lieu of an arithmetic logic unit (ALU), the Boolean Processor 10 includes a Boolean logic unit (BLU) 38. In terms of its size, speed, and functionality, the architecture of the Boolean Processor 10 is designed to be inexpensive, scalable, and efficient. The Boolean Processor 10 achieves these benefits through a simple design that is optimized for performing the short-circuit evaluation of complex Conjunctive Normal Form (CNF) Boolean expressions, Disjunctive Normal Form (DNF) Boolean expressions, or both.

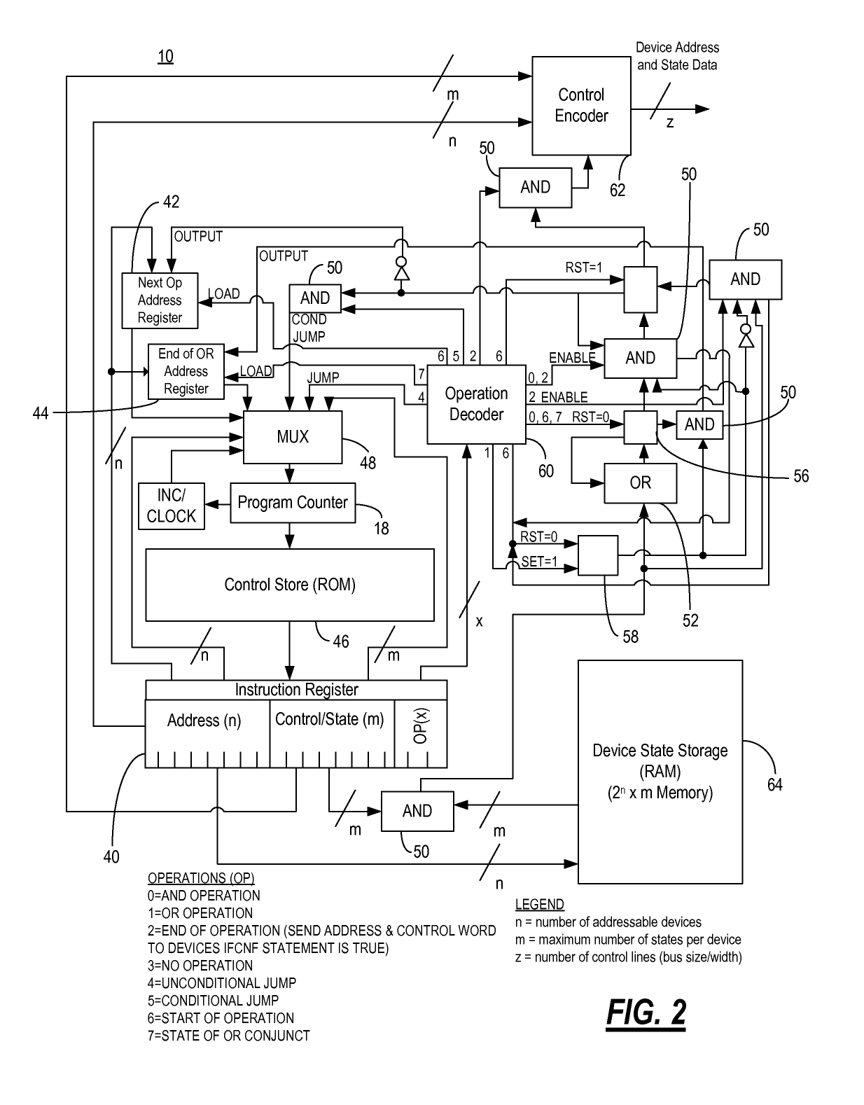

Referring to FIG. 2, in an exemplary embodiment, the architecture of a CNF Boolean Processor 10 is illustrated. For illustration purposes of describing the architecture of the CNF Boolean Processor 10, 8-bit device addressing and 8-bit control words are used. This results in the architecture of the CNF Boolean Processor 10 supporting 256 devices, each device having 256 possible states. Optionally, the architecture of the CNF Boolean Processor 10 can be scaled to accommodate 2″ devices, each device having 2 m possible states, where n and m are the number of device address bits and the number of possible states for each device, respectively. The defining feature of the architecture of the CNF Boolean Processor 10 is its set of registers, or lack thereof. In contrast to conventional microprocessors and microcontrollers, which can have a plurality of registers (typically from 8 to 64 bits wide), the CNF Boolean Processor 10 has only six registers. Of the six registers, the instruction register 40, the next operation address register 42, and the end of OR address register 44 are the only registers which are generally required to be multi-bit registers. The remaining three registers 54, 56, 58 hold AND truth states, OR truth states, and an indicator for conjuncts containing OR clauses. Each of these registers 54, 56, 58 may be only a single bit in size, although additional bits may be included if desired.

The CNF Boolean Processor 10 includes the instruction register 40, which is an n+m+x-bit wide register containing an n-bit address, an m-bit control/state word, and an x-bit operational code. Using 8-bit device addressing, 8-bit control words, and 3-bit operational codes, the instruction register 40 is 19 bits wide. The CNF Boolean Processor 10 also includes a control store (ROM) 46, which is used to hold a compiled micro-program, including (n+m+x)-bit instructions. The CNF Boolean Processor 10 further includes the program counter 18, which is used for fetching the next instruction from the control store 46. The CNF Boolean Processor 10 further includes circuitry (MUX) 48, which is used to configure the program counter 18 for normal operation, conditional jump operation, unconditional jump operation, and Boolean short-circuit operation. Six AND gates 50 and one OR gate 52 are used to pass operation results and a plurality of signals that are operational code dependent.

The AND register 54 is used to roll up the results of the conjuncts. If the AND register 54 is one bit in size, then the default value of the AND register 54 is one and it initializes to a value of one after a start of operational code. The 1-bit AND register 54 remains at a value of one if all of the conjuncts in the Boolean expression being evaluated are true. If this bit is set to zero at any time during the evaluation, the entire CNF operation is false. In such a case, the remainder of the operation may be short-circuited and the evaluation of the next operation can begin. It should be apparent, however, that the AND register 54 may be modified such that one or more alternative values may be used to initialize the register 54 and represent a “true” value. The same applies to a “false” value as well, where any of another set of values (provided that the selected value is different from the one(s) used to represent a “true” value) may be used to represent a “false” value.

The OR register 56 is used to roll up the results of each of the individual conjuncts. If the OR register 56 is one bit in size, then it initializes to a value of zero and remains in that state until a state in a conjunct evaluates to one. The OR conjunct register 58 is used to indicate that the evaluation of a conjunct containing OR clauses has begun. It initializes to a value of zero and remains in that state until an OR operation sets its value to zero. It should be apparent, however, that the OR register 56 may be modified such that one or more alternative values may be used to initialize the register 56 and represent a “false” value. The same applies to a “true” value as well, where any of another set of values (provided that the selected value is different from the one(s) used to represent a “false” value) may be used to represent a “true” value. Finally, if the OR conjunct register 58 is one bit in size, then it initializes to a value of zero and remains in that state until an OR operation sets its value to one. It should be apparent, however, that the OR conjunct register 58 may be modified such that one or more alternative values may be used to initialize the register 58 and represent a “false” value. The same applies to a “true” value as well, where any of another set of values (provided that the selected value is different from the one(s) used to represent a “false” value) may be used to represent a “true” value. In the event that the 1-bit OR conjunct register 58 is set to one and the 1-bit OR register 56 is set to one, the entire conjunct evaluates to true and short-circuits to the start of the next conjunct.

The CNF Boolean Processor 10 further includes an operation decoder 60, which deciphers each operational code and controls the units that are dependent upon each operational code. In an embodiment preferred for its simplicity, the operational codes are 3 bits in length, and the functions of the operation decoder 60 by operational code include: Boolean AND (Op Code 0), Boolean OR (Op Code 1), End of Operation (Op Code 2), No Operation (Op Code 3), Unconditional Jump (Op Code 4), Conditional Jump (Op Code 5), Start of Operation (Op Code 6), and Start of Conjunct (Op Code 7). However, it will be apparent that the inclusion of one or more additional bits in the instruction register 40 would permit additional operational codes to be offered, and that the removal of a bit would reduce the number of operational codes offered, if either such design were to be desired.

A control encoder 62 accepts n+m bits in parallel (representing a device address and control word) and outputs them across a device bus (control lines) either serially or in parallel, depending upon the architecture of the given device bus. The next operation address register 42 stores the address used for Boolean short-circuiting. Short-circuiting occurs as soon as a conjunct evaluates to false. In such a case, the address is the address of the next operation. The end of OR address register 44 stores the address of the instruction immediately following a conjunct containing OR clauses. It is used for the short-circuiting of conjuncts that contain OR clauses. In the event that the OR conjunct register 58 has a value of true and the OR register 56 has a value of true, short-circuiting will occur and the next conjunct will be evaluated. The CNF Boolean Processor 10 further includes a device state storage (RAM) 64, which is responsible for storing the states of the devices that the CNF Boolean Processor 10 monitors and/or controls. It has 2″ addresses, each of which are m-bits wide, where n is the address width and m is the control/state word width, in bits.

The CNF Boolean Processor 10 evaluates micro-programs and controls its environment based upon the results of the above-described evaluations. The micro-programs define the actions to be taken by devices in the event that given Boolean tests evaluate to true. The CNF Boolean Processor 10 works on the principle that the devices will be controlled based upon their states and the states of other devices, or after some period of time has elapsed. In order to evaluate a micro-program as efficiently as possible, conditional tests should be compiled into CNF.

The CNF Boolean Processor 10 performs eight functions, as specified by operational code. Op Code 0—(Boolean AND) enables the AND gate 50 that loads the AND register 54 in the event that the conditional state of the device at the address in the instruction register 40 equals the state being tested in the instruction register 40. The Boolean AND instruction is used to roll up results between OR conjuncts. This is accomplished by ANDing the value of the AND register 54 with the value of the OR register 56. Op Code 1—(Boolean OR) sets the value of the OR conjunct register 58 to one, which enables short-circuiting within a conjunct containing OR clauses. Op Code 2—(End of Operation) enables the AND gate 50 that AND's the value of the OR register 56 with the value of the AND register 54. If the AND register 54 evaluates to a value of one, the control encoder 62 is enabled and the address and control word specified in the end of operation code is sent to the proper device. Op Code 3—(No Operation) does nothing. Op Code 4—(Unconditional Jump) allows the MUX 48 to receive an address from an address portion of the instruction register 40 and causes an immediate jump to the instruction at that address. Op Code 5—(Conditional Jump) provides that if the AND register 54 has a value of one, the test condition is met and the MUX 48 is enabled to receive the “jump to” address from the address portion of the instruction register 40. Op Code 6—(Start of Operation) provides the address of the line following the end of operation line for the current operation. This address is used to short-circuit the expression and keep the CNF Boolean Processor 10 from having to evaluate the entire CNF expression in the event that one of the conjuncts evaluates to zero. In addition to loading the next operation address into the next operation address register 42, this operation also sets the AND register 54 to one, the OR register 56 to zero and the OR conjunct register 58 to zero. Op Code 7—(Start of OR Conjunct) provides the address of the line immediately following the conjunct and loads it into the end of OR address register 44. This address is used to provide short-circuiting out of a given conjunct in the event that one of the conjunct's terms evaluates to one.

The evaluation of a CNF expression begins with Start of Operation (Op Code 6) and proceeds to the evaluation of a conjunct. A conjunct may be either a stand-alone term (evaluated as an AND operation) or a conjunct containing OR clauses. In the latter case, each term of the conjunct is evaluated as part of an OR operation (Op Code 1). Each of these operations represents a test to determine if the state of a given device is equal to the state value specified in the corresponding AND or OR instruction. If the term evaluates to true, the OR-bit is set to a value of one. Otherwise, the OR-bit is set to a value of zero. In the case of a stand-alone term, this value automatically rolls up to the AND register 54. In conjuncts containing OR clauses, the result of each OR operation is OR'd with the current value of the OR register 56. This ensures that a true term anywhere in the conjunct produces a final value of true for the entire conjunct evaluation. In the event that the OR register 56 has a value of one and the OR conjunct register 58 is set to one, the conjunct will evaluate to true and may be short-circuited to the next conjunct. Next, the CNF Boolean Processor 10 prepares for subsequent conjuncts (if any additional conjuncts exist). At this point, an AND operation (Op Code 0) joins the conjuncts and the value of the OR register 56 is rolled up to the AND register 54 by having the value of the OR register 56 AND'd with the value of the AND register 54. In the event that the OR-bit has a value of zero when the AND operation is processed, the AND-bit will change to a value of zero. Otherwise, the AND-bit's value will remain at one. If the AND-bit has a value of one, the next conjunct is evaluated. If the AND-bit has a value of zero, the final value of the CNF expression is false, regardless of the evaluation of any additional conjuncts. At this point, the remainder of the expression may be short-circuited and the next CNF expression can be evaluated.

Preferably, the CNF Boolean Processor 10 requires that functions be compiled in CNF. A micro-code compiler builds the micro-instructions such that they follow a CNF logic. The logic statements for CNF Boolean Processor programs are nothing more than IF-THEN-ELSE statements. For example: IF (Device A has State Ax), THEN (Set Device B to State By), ELSE (Set Device C to State Cz). The logic of the IF expression must be compiled into CNF. The expression must also be expanded into a set of expressions AND'd together, and AND'd with a pre-set value of “true”. For the CNF operation, the pre-set value of “true” is the initial value of the AND register 54 at the start of each logical IF operation. The above IF-THEN-ELSE statement would result in the following micro-code logic: [(Device A has State Ax) ̂ “true”]; if the AND statement is “true”, then (SET Device B to State By); and if the AND statement is “false”, then (SET Device C to State Cz).

The next operation address register 42 and the end of OR address register 44 may be loaded with values from the n-bit “address” portion of the instruction register 40. As described previously, these values specify the addresses of lines of code within the micro-program that are jumped to when performing short circuit operations. However, this design limits the number of micro-program lines (or micro-program addresses) that can be accessed by the next operation address register 42 and the end of OR address register 44 to 2′, where n is the width, in bits, of the address portion of the instruction register 40.

In order to expand the micro-program address values that can be stored in the next operation address register 42 and the end of OR address register 44, the architecture may be modified to use the bits from both the address and control/state portions of the instruction register 40 when loading the next operation address register 42 and the end of OR address register 44 with the values of micro-program addresses. This would expand the number of micro-program lines (or micro-program addresses) that can be accessed by the next operation address register 42 and the end of OR address register 44 to 2^{n+m}, where n is the width, in bits, of the address portion of the instruction register 40 and m is the width, in bits, of the control/state portion of the instruction register 40. This approach would require the “control/state” portion of the instruction register 40 to be connected directly to the address registers 42, 44 in addition to the MUX 48.

Another solution for expanding the range of micro-program address values that may be used is to modify the control store portion of the architecture to include discrete “jump to” addresses that would only be utilized on instructions that are capable of being jumped to. While the limit on the number of instructions that may be jumped to would remain the same in this case, the inclusion of discrete jump to addresses would permit the “jump to” addresses to be dispersed throughout the entire micro-program, as opposed to being limited to the first 2ⁿ instructions, where n is the width, in bits, of the address portion of the instruction register 40. In order to utilize this approach, the control store 46 may include a secondary addressing scheme to associate “jump to” addresses to widely dispersed primary physical address locations in the store. Primary addressing in the control store 46 would still need to be maintained for use by the program counter 18 and also for updating the program counter 18 when a location is “jumped to.” For example, a word in the control store 46 could have a primary physical address of 10 and a secondary “jump to” address of 1. If the state of the processor 36 dictates a jump to “jump to” address 1, then the program counter 18 would need to be updated to 10, or the actual primary physical address of “jump to” address 1. The previously mentioned solution, however, in which the address and control/state portions of the instruction register 40 are utilized, is the preferred solution.

A distinct characteristic of the CNF Boolean Processor 10 is the type of expressions it is designed to evaluate; namely expressions in CNF. Optionally, using a similar register design, a DNF-based architecture can also be implemented, as described herein below. However, the architecture of the CNF Boolean Processor 10 focuses on CNF, providing the fastest and most scalable design.

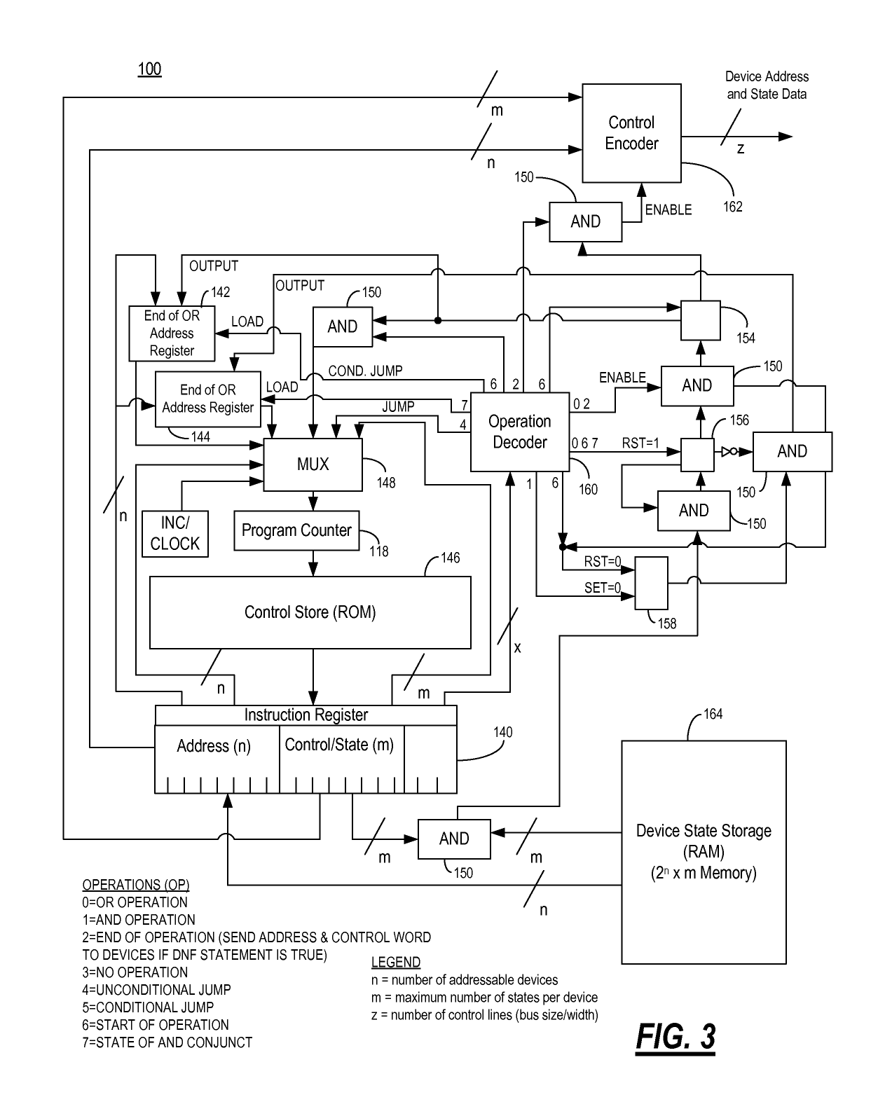

Referring to FIG. 3, in an exemplary embodiment, the architecture of a DNF Boolean Processor 100 is illustrated. For the purposes of describing the architecture of the DNF Boolean Processor 100, 8-bit device addressing and 8-bit control words are used. This results in the architecture of the DNF Boolean Processor 100 supporting 256 devices, each device having 256 possible states. Optionally, the architecture of the DNF Boolean Processor 100 can be scaled to accommodate 2ⁿ devices, each device having 2^{m} possible states, where n and m are the number of device address bits and the number of possible states for each device, respectively. The defining feature of the architecture of the DNF Boolean Processor 100 is its set of registers, or lack thereof. In contrast to conventional microprocessors and microcontrollers, which can have a plurality of registers (typically from 8 to 64 bits wide), the DNF Boolean Processor 100 has only six registers. Of the six registers, the instruction register 140, the end of operation address register 142, and the end of AND address register 144 are the only registers which are generally required to be multi-bit registers. The remaining three registers 154, 156, 158 hold AND truth states, OR truth states, and an indicator for disjuncts containing AND clauses. Each of these registers 154, 156, 158 may be only a single bit in size, although additional bits may be included if desired.

The DNF Boolean Processor 100 includes the instruction register 140, which is an n+m+x-bit wide register containing an n-bit address, an m-bit control/state word, and an x-bit operational code. Using 8-bit device addressing, 8-bit control words, and 3-bit operational codes, the instruction register 140 is 19 bits wide. The DNF Boolean Processor 100 also includes a control store (ROM) 146, which is used to hold a compiled micro-program, including (n+m+x)-bit instructions. The DNF Boolean Processor 100 further includes the program counter 118, which is used for fetching the next instruction from the control store 146. The DNF Boolean Processor 100 further includes a memory (MUX) 148, which is used to configure the program counter 118 for normal operation, conditional jump operation, unconditional jump operation, and Boolean short-circuit operation. Six AND gates 150 are used to pass operation results and a plurality of signals that are operational code dependent.

The OR register 154 is used to roll up the results of the disjuncts. If the OR register 154 is one bit in size, then the default value of the OR register 154 is zero and it initializes to a value of zero after a start of operational code. The 1-bit OR register 154 remains at a value of zero if all of the disjuncts in the Boolean expression being evaluated are false. If this bit is set to one at any time during the evaluation, the entire DNF operation is true. In such a case, the remainder of the operation may be short-circuited and the control operation that occurs as the result of a true evaluation can be executed. It should be apparent, however, that the OR register 154 may be modified such that one or more alternative values may be used to initialize the register 54 and represent a “false” value. The same applies to a “true” value as well, where any of another set of values (provided that the selected value is different from the one(s) used to represent a “false” value) may be used to represent a “true” value.

The AND register 156 is used to roll up the results of each of the individual disjuncts. If the AND register 156 is one bit in size, then it initializes to a value of one and remains in that state until a state in a disjunct evaluates to false. The AND disjunct register 158 is used to indicate that the evaluation of a disjunct containing AND clauses has begun. It initializes to a value of zero and remains in that state until an AND operation sets its value to one. It should be apparent, however, that the AND register 156 may be modified such that one or more alternative values may be used to initialize the register 156 and represent a “true” value. The same applies to a “false” value as well, where any of another set of values (provided that the selected value is different from the one(s) used to represent a “true” value) may be used to represent a “false” value. Finally, if the AND disjunct register 158 is one bit in size, then it initializes to a value of zero and remains in that state until an AND operation sets its value to one. It should be apparent, however, that the AND disjunct register 158 may be modified such that one or more alternative values may be used to initialize the register 158 and represent a “false” value. The same applies to a “true” value as well, where any of another set of values (provided that the selected value is different from the one(s) used to represent a “false” value) may be used to represent a “true” value. In the event that the 1-bit AND disjunct register 158 is set to one and the 1-bit AND register 156 is set to zero, the entire disjunct evaluates to false and short-circuits to the start of the next disjunct.

The DNF Boolean Processor 100 further includes an operation decoder 160, which deciphers each operational code and controls the units that are dependent upon each operational code. In an embodiment preferred for its simplicity, the operational codes are 3 bits in length, and the functions of the operation decoder 60 by operational code include: Boolean OR (Op Code 0), Boolean AND (Op Code 1), End of Operation (Op Code 2), No Operation (Op Code 3), Unconditional Jump (Op Code 4), Conditional Jump (Op Code 5), Start of Operation (Op Code 6), and Start of AND Disjunct (Op Code 7). However, it will be apparent that the inclusion of one or more additional bits in the instruction register 140 would permit additional operational codes to be offered, and that the removal of a bit would reduce the number of operational codes offered, if either such design were to be desired.

A control encoder 162 accepts n+m bits in parallel (representing a device address and control word) and outputs them across a device bus (control lines) either serially or in parallel, depending upon the architecture of the given device bus. The end of operation address register 142 stores the address used for Boolean short-circuiting. Short-circuiting occurs as soon as a disjunct evaluates to true. In such a case, the address is the address of the final control portion of the expression which results in the event that the entire DNF expression is true. The end of AND address register 144 stores the address of the instruction immediately following a disjunct containing AND clauses. It is used for the short-circuiting of disjuncts that contain AND clauses. The DNF Boolean Processor 100 further includes a device state storage (RAM) 164, which is responsible for storing the states of the devices that the DNF Boolean Processor 100 monitors and/or controls. It has 2ⁿ addresses, each of which are m-bits wide, where n is the address width and m is the control/state word width, in bits.

The DNF Boolean Processor 100 evaluates micro-programs and controls its environment based upon the results of the above described evaluations. The micro-programs define the actions to be taken by devices in the event that the given Boolean tests evaluate to true. The DNF Boolean Processor 100 works on the principle that the devices will be controlled based upon their states and the states of other devices, or after some period of time has elapsed. In order to evaluate a micro-program as efficiently as possible, conditional tests should be compiled into Boolean Disjunctive Normal Form (DNF).

The DNF Boolean Processor 100 performs eight functions, as specified by operational code. Op Code 0—(Boolean OR) enables the AND gate 150 that loads the OR register 154 in the event that the conditional state of the device at the address in the instruction register 140 equals the state being tested in the instruction register 140. The Boolean OR instruction is used to roll up results between AND disjuncts. This is accomplished by ORing the value of the OR register 154 with the value of the AND register 156. Op Code 1—(Boolean AND) sets the value of the AND disjunct register 158 to one, which enables short-circuiting within a disjunct containing AND clauses. Op Code 2—(End of Operation) enables the AND gate 150 that passes the value of the AND register 156 to the OR register 154. If the OR register 154 ever evaluates to a value of one, the program is short-circuited to the end of operation instruction (the control operation that executes in the event of a true evaluation) and the control encoder 162 is enabled and the address and control word specified in the end of operation code is sent to the proper device. Op Code 3—(No Operation) does nothing. Op Code 4—(Unconditional Jump) allows the MUX 148 to receive an address from the address portion of the instruction register 140 and causes an immediate jump to the instruction at that address. Op Code 5—(Conditional Jump) provides that if the OR register 154 has a value of one, the test condition is met and the MUX 148 is enabled to receive the “jump to” address from the address portion of the instruction register 140. Op Code 6—(Start of Operation) provides the address of the final control portion of the current operation. This address is used to short-circuit the expression and keep the DNF Boolean Processor 100 from having to evaluate the entire DNF expression in the event that one of the disjuncts evaluates to one. In addition to loading the end of operation address into the end of operation address register 142, this operation also sets the OR register 154 to zero, the AND register 156 to one and the AND disjunct register 158 to zero. Op Code 7—(Start of AND Disjunct) provides the address of the line immediately following the disjunct and loads it into the end of AND address register 144. This address is used to provide short-circuiting out of a given disjunct in the event that one of the disjunct's terms evaluates to zero.

The evaluation of a DNF expression begins with Start of Operation (Op Code 6) and proceeds to the evaluation of a disjunct. A disjunct may be either a stand-alone term (evaluated as an OR operation) or a disjunct containing AND clauses. In the latter case, each term of the disjunct is evaluated as part of an AND operation (Op Code 1). Each of these operations represents a test to determine if the state of a given device is equal to the state value specified in the corresponding OR or AND instruction. If the term evaluates to false, the AND-bit is set to a value of zero. Otherwise, the AND-bit is set to a value of one. In the case of a stand-alone term, this value automatically rolls up to the OR register 154. In disjuncts containing AND clauses, the result of each AND operation is AND'd with the current value of the AND register 156. This ensures that a false term anywhere in the disjunct produces a final value of false for the entire disjunct evaluation. In the event that the AND register 156 has a value of zero and the AND disjunct register 158 is set to one, the disjunct will evaluate to false and may be short-circuited to the next disjunct. Next, the DNF Boolean Processor 100 prepares for subsequent disjuncts (if any additional disjuncts exist). At this point, an OR operation (Op Code 0) joins the disjuncts and the value of the AND register 156 is rolled up to the OR register 154 by having the value of the AND register 156 passed through to the OR register 154. In the event that the AND-bit has a value of one when the OR operation is processed, the OR-bit will change to a value of one. Otherwise, the OR-bit's value will remain at zero. If the OR-bit has a value of zero, the next disjunct is evaluated. If the OR-bit has a value of one, the final value of the DNF expression is true, regardless of the evaluation of any additional disjuncts. At this point, the remainder of the expression may be short-circuited and the final control portion of the current operation may be executed.

Preferably, the DNF Boolean Processor 100 requires that functions be compiled in DNF. A micro-code compiler builds the micro-instructions such that they follow a DNF logic. The logic statements for DNF Boolean Processor programs are nothing more than IF-THEN-ELSE statements. For example: IF (Device A has State Ax), THEN (Set Device B to State By), ELSE (Set Device C to State Cz). The logic of the IF expression must be compiled into DNF. The expression must also be expanded into a set of expressions OR'd together, and OR'd with a pre-set value of “false”. For the DNF operation, the pre-set value of “false” is the initial value of the OR register 154 at the start of each logical IF operation. The above IF-THEN-ELSE statement would result in the following micro-code logic: [(Device A has State Ax) V “false”]; if the OR statement is “true”, then (SET Device B to State By); and if the OR statement is “false”, then (SET Device C to State Cz).

Once again, as illustrated in FIG. 3, the end of operation address register 142 and the end of AND address register 144 may be loaded with values from the n-bit “address” portion of the instruction register 140. However, in order to expand the micro-program address values that can be stored in the end of operation address register 142 and the end of AND address register 144, the architecture may be modified to use the bits from both the address and control/state portions of the instruction register 140 when loading the end of operation address register 142 and the end of AND address register 144 with the values of micro-program addresses. This approach would require the “control/state” portion of the instruction register 140 to be connected directly to the address registers 142, 144 in addition to the MUX 148. Further, as with the CNF Boolean Processor 10, another solution is to modify the control store portion of the architecture to include discrete “jump to” addresses that would only be utilized on instructions that are capable of being jumped to, as described previously.

A distinct characteristic of the DNF Boolean Processor 100 is the type of expressions it is designed to evaluate; namely expressions in DNF. It should be noted that the DNF Boolean Processor 100 performs both inter and intra-term short-circuit evaluations, thereby providing maximum efficiency in processing expressions.

Two types of short-circuiting exist in CNF and DNF operations, inter-term short-circuiting and intra-term short-circuiting. Inter-term short-circuiting causes the evaluation of an entire expression to evaluate to true, in the case of DNF, or false, in the case of CNF, if any term evaluates to true or false, respectively. Intra-term short-circuiting causes the evaluation of a conjunct or disjunct to terminate without full evaluation. In this instance, a CNF term, or conjunct, will evaluate to true if any of its sub-terms are true, while a DNF term, or disjunct, will evaluate to false if any of its sub-terms are false. Consider the following statements:

CNF: If (A or B) and (C or D) then E (7)

DNF: If (A and B) or (C and D) then E (8)

In the CNF statement, if A evaluates to true, the entire conjunct A or B evaluates to true. As a result, the evaluation of B is unnecessary and can be avoided using intra-term short-circuit evaluation. From an inter-term perspective, if the conjunct A or B evaluates to false, the entire CNF expression evaluates to false, making the evaluation of the conjunct C or D superfluous. In the case of DNF, both inter and intra-term short-circuit evaluation work similarly to that of CNF, except that the term values for DNF are the converse of those for CNF. It should be noted that the Boolean Processors 10, 100 perform both inter and intra-term short-circuit evaluations, thereby providing maximum efficiency in processing expressions.

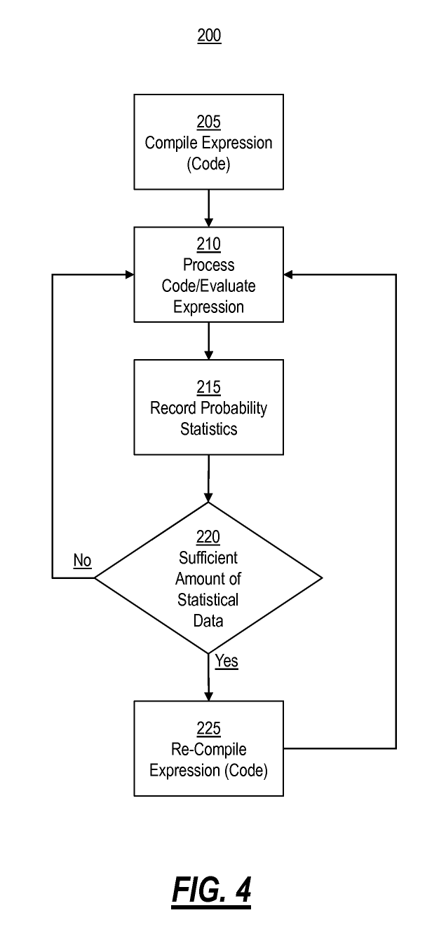

Referring to FIG. 4, in an exemplary embodiment, a flowchart illustrates a re-compiling process 200 for use with the preferred embodiments of the present invention. Still further efficiencies of Boolean Processor technology, relative to conventional microcontrollers and microprocessors such as those described hereinabove, may be provided through the use of intelligent compiling or configuring when ordering terms, conjuncts, disjuncts and/or other operations. This process 200 may be used in conjunction with either a CNF Boolean Processor 10 or a DNF Boolean Processor 100.

In a CNF Boolean Processor 10, the efficiency of the short circuiting of CNF expressions can be maximized by: C1. Evaluating terms within conjuncts that are most likely to be true as early as possible in the overall evaluation of each conjunct. C2. Evaluating conjuncts that are most likely to evaluate to false as early as possible in the overall evaluation of the CNF expression. As shown in FIG. 4, the re-compiling process 200 begins at step 205 with an initial compiling of the code representing the Boolean expressions. The process 200 then enters a loop which begins with the code actually being processed and the expressions themselves being evaluated at step 210. The next step 215 in the loop is to determine (or update) the probabilities of terms within conjuncts evaluating to true and/or false and to store the updated probability information in some form in a memory. As the CNF expressions are evaluated over multiple iterations, the stored probabilities tend to become more accurate. When at step 220 it is determined that a sufficient amount of statistical data has been gathered and included in the calculation of probabilities, the process proceeds at step 225 to re-compile the code representing the Boolean expressions in order to place it in an order likely to maximize the efficiency of the evaluations as described above in C1 and C2. This process 200 may be repeated as often as desired or as often as is likely to improve the efficiency of the operation of the CNF Boolean Processor 10. Similarly, in a DNF Boolean Processor 100, the efficiency of the short circuiting of DNF expressions can be maximized by: D1. Evaluating terms within disjuncts that are most likely to be false as early as possible in the overall evaluation of each disjunct. D2. Evaluating disjuncts that are most likely to evaluate to true as early as possible in the overall evaluation of the DNF expression. The re-compiling process 200 is the same as that for the CNF Boolean Processor 10 except that code represents DNF expressions that are evaluated and for which probabilities are determined before re-compiling the code in order to place it in an order likely to maximize the efficiency of the evaluations as described above in D1 and D2.

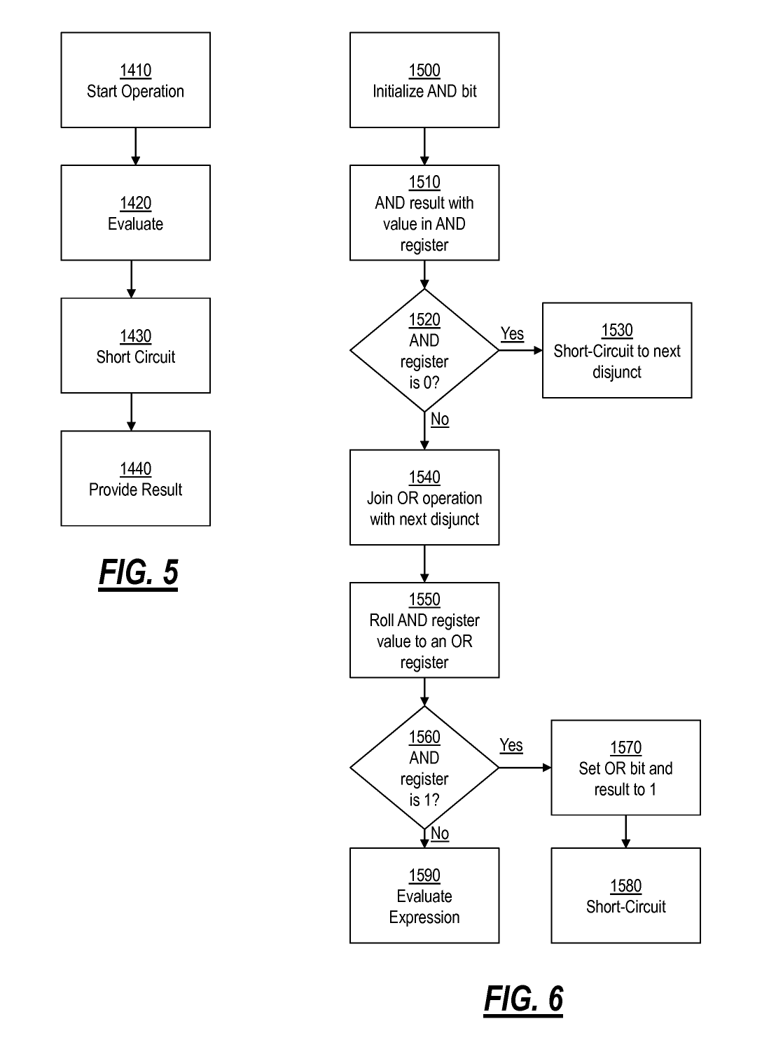

Referring to FIG. 5, in an exemplary embodiment, a flow chart illustrates a method for processing a Boolean expression. In the embodiment depicted in FIG. 5, a method may be provided for processing a Boolean expression using a Boolean Processor. In some embodiments, the method includes one or more of the following steps: Step 1410: In some embodiments, the operation is started. The operation may be an operation related to a Normal Form Boolean expression. The Boolean expression may include a conjunct or a disjunct. In further embodiments, the step of starting an operation includes starting an operation related to a DNF Boolean expression. The Boolean expression may include a disjunct. Step 1420: In further embodiments, the method includes evaluating the conjunct or disjunct. A plurality of terms of the disjunct may be evaluated as part of an AND operation. In some embodiments, the step of evaluating includes evaluating the disjunct. In various embodiments, the disjunct may be a stand-alone term evaluated as an OR operation. In further embodiments, the disjunct includes an AND clause. In other exemplary embodiments, the operation may include an operation related to a CNF Boolean expression, and the Boolean expression may include a conjunct.

This evaluation step may take place in a number of manners, an example is depicted in FIG. 6 and described in the accompanying description. In further embodiments, the evaluating step may include separating the Boolean expression into separate conjuncts or disjuncts. Further this step may include distributing each separate conjunct or disjunct to a separate Boolean Processor for evaluation. Step 1430: In some embodiments, the method includes selectively short-circuiting a portion of the Boolean expression. In some embodiments involving multiple Boolean Processors, if a conjunct in a first Boolean Processor results in a false evaluation, a signal may be provided to one or more separate Boolean Processors. The signal may indicate that the entire expression is false. In further embodiments involving multiple Boolean Processors, if a disjunct in a first Boolean Processor results in a true evaluation, a signal may be provided to one or more separate Boolean Processors. The signal may indicate that the entire expression is true. Step 1440: In some embodiments, the method includes providing a result. The result may be provided to one or more processors or other devices via means described herein and/or otherwise known in the art.

Referring to FIG. 6, in an exemplary embodiment, a flow chart illustrates a method for evaluating a Boolean expression. In some embodiments, the method includes one or more of the following steps: Step 1500: In some embodiments, the method may include initializing the value of an AND-bit to a first predetermined value and setting the value of the AND-bit to a second predetermined value that differs from the first predetermined value. Step 1510: In some embodiments, the method may include, in a disjunct including an AND clause, AND'ing the result of each AND operation with the current value of an AND register. Steps 1520-1530: In some embodiments, in the event that the AND register has a value of ‘zero’, or its logical equivalent, and an AND disjunct register is set to ‘one’, or its logical equivalent, the disjunct is evaluated to false. Further, the method may include short-circuiting to a next disjunct. Step 1540: In some embodiments, if the AND register does not have a value of ‘zero,’ the method may include evaluating the next term in the disjunct, if one exists, or joining an OR operation and the next disjunct. Step 1550: In some embodiments, the method may include rolling the value of the AND register up to an OR register. This may be accomplished by OR'ing the value of the AND register with the value of the OR register. Steps 1560-1580: In some embodiments, the method may determine whether the AND-bit has a value of ‘true’, or its logical equivalent, when the OR operation is processed. If the AND-bit has a value of ‘true,’ or its logical equivalent, the OR-bit may be set to a value of ‘true’ or its logical equivalent. In some embodiments, the final value of the Boolean expression is set to ‘true’, or its logical equivalent, if the OR-bit has a value of ‘true’, or its logical equivalent. In some embodiments, the remainder of the Boolean expression is true and is short-circuited. Step 1590: In Some embodiments, if the AND-bit does not have a value of ‘true’, or its logical equivalent, then the expression is evaluated as described herein and/or in other ways known in the art. In some embodiments, the method may take place as part of a subroutine. Exiting the subroutine may be accomplished via an unconditional jump. The jump may be to the instruction immediately following the jump instruction that initiated the subroutine. For example, step 1590 may loop back to step 1500.

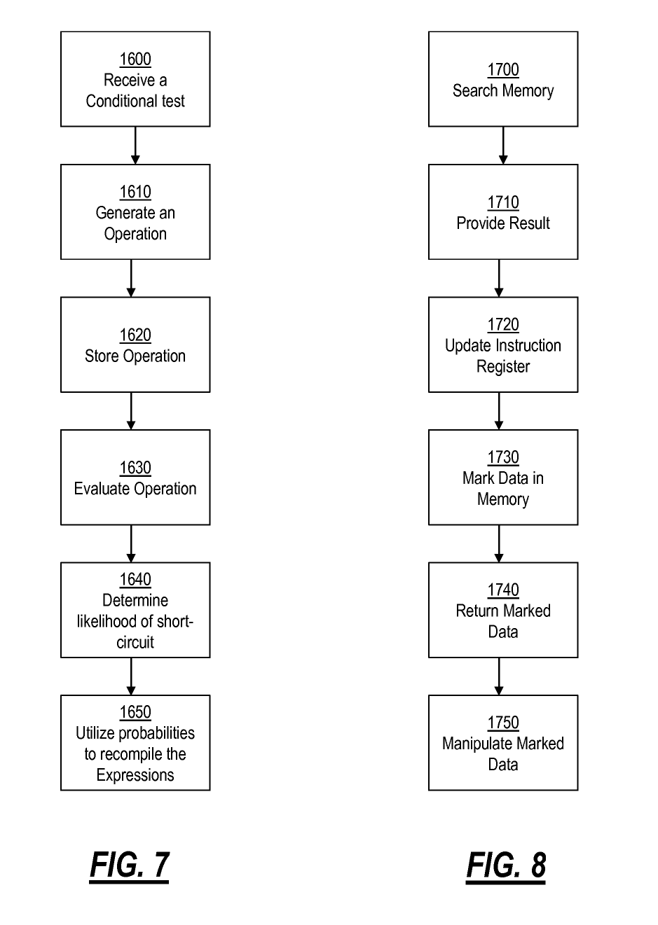

Referring to FIG. 7, in an exemplary embodiment, a flow chart illustrates a compiling method. The method may include one or more of the following steps: Step 1600: In some embodiments, a plurality of conditional tests may be received. The conditional tests may be of any type disclosed herein and/or known in the art. Step 1610: In some embodiments, an operation is generated. The operation may be generated in computer-readable format. In some embodiments, the operation is representative of a Boolean expression in CNF. In some embodiments, the operation is representative of a Boolean expression in DNF. This step may include considering whether the Boolean expression is in DNF or CNF. Step 1620: In some embodiments, the operation is stored in a Boolean Processor. The operation may include a plurality of portions. For example, a first of the plurality of portions may be more likely to create a short-circuit condition than at least a second of the plurality of portions. The generated operation may include ordering the plurality of portions within the operation such that the first of the plurality of portions is likely to be processed before the second of the plurality of portions. Step 1630: In some embodiments, the operation is processed by a Boolean Processor. The Boolean Processor may be operated to evaluate the expression by processing the operation and selectively short-circuiting at least a portion of the Boolean expression. Step 1640: As described herein, for example in connection with step 1620, the operation may include a plurality of portions. In some such embodiments, the relative likelihood of at least the first and second of the plurality of portions to create a short-circuit condition may be determined. This determination may be repeated periodically. In further embodiments, the probability of one or more of a plurality of portions to create a short-circuit condition may be stored, for example, in a memory. The method may further include a step 1650 where the probabilities are used to recompile the expressions as described in FIG. 4.

Referring to FIG. 8, in an exemplary embodiment, a flow chart illustrates a method for processing a Boolean expression. The method may include one or more of the following steps: Step 1700: In some embodiments, a method for processing a Boolean expression using a Boolean Processor may be provided. Such a method may include the step of searching a memory for data that meets criteria. The criteria may be specified in an Instruction Register. The processor may be located on a memory chip. Step 1710: In some embodiments, a result is provided. The result may be provided to one or more processors and/or other devices. Further the result may be provided via any communication means disclosed herein or otherwise known in the art. Step 1720: In some embodiments, the Instruction Register may be updated. The Instruction may be dynamically updated. As a result of being updated, the Instruction Register may search the memory against one or more criteria. Step 1730: In some embodiments, data is marked in memory. The marked data may be data that meets the specified criteria. Step 1740: In some embodiments, the marked data is returned. The marked data may be returned to the requesting hardware or software. It may be returned by any communication means disclosed herein or otherwise known in the art. Step 1750: In some embodiments, the marked data is manipulated. The marked data may be manipulated within the memory.

The Boolean Processor may be utilized in environments in which a set of operations will be repeated over subsets of data. In some applications, the sets of operations that are repeated only differ by the starting addresses of the memory locations that they are accessing. Thus, in some embodiments, it makes sense to support repetitive operations via the utilization of memory address offsets.

This functionality may be implemented in a number of ways. For example, one embodiment includes additional operations and/or registers for storing offset values. Another embodiment includes additional operations and/or logic for maintaining and modifying the offset values. For example, the additional operations and/or logic may facilitate incrementing, decrementing, or otherwise modifying the offset values. A pseudo-code example of an exemplary embodiment is as follows:

Task: Test each of 10 memory locations for the value x.

Without Support for Repetitive Operations: 1. Test location 1; 2. Test location 2; . . . ; 10. Test location 10.

With Support for Repetitive Operations: 1. Set offset=0; 2. Test Location 1+Offset; 3. Increment Offset; 4. If offset<10, go to Step 2.

The Boolean Processors described herein are exemplary embodiments and the present invention contemplates any such processor utilizing any physical implementation. For example, the Boolean Processor may be implemented in any custom made or commercially available processor, a central processing unit (CPU), an auxiliary processor among several processors associated with a computer, a semiconductor-based microprocessor (in the form of a microchip or chip set), special purpose logic devices (e.g., application specific integrated circuits (ASICs)) or configurable logic devices (e.g., simple programmable logic devices (SPLDs), complex programmable logic devices (CPLDs), field programmable gate arrays (FPGAs)), or generally any device for executing instructions. Additional exemplary embodiments of Boolean Processors are further described in U.S. patent application Ser. No. 12/033,644 filed on Feb. 19, 2008 and entitled “BOOLEAN PROCESSOR” and in U.S. patent application Ser. No. 12/364,047 filed on Feb. 2, 2009 and entitled “ENHANCED BOOLEAN PROCESSOR,” the parent application of the present application. Those of ordinary skill in the art will recognize the present invention contemplates use with any Boolean Processor, such as any device capable of implementing the exemplary methods described in FIGS. 5-8.

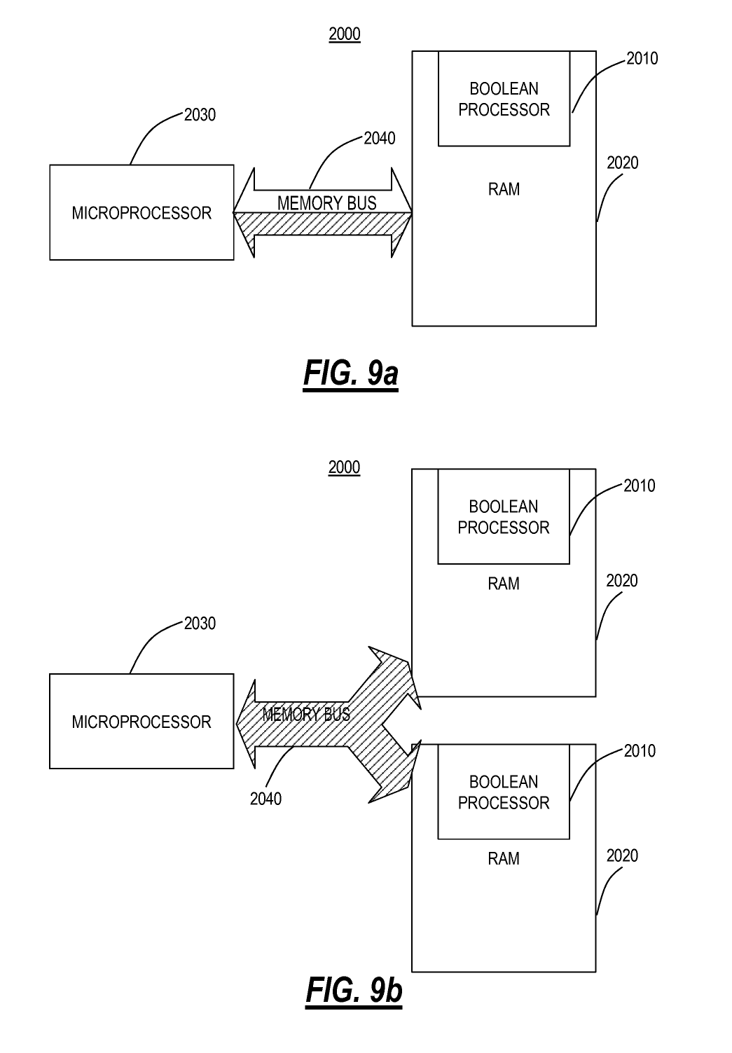

Referring to FIGS. 9a-9b, in an exemplary embodiment, a block diagram illustrates a Chip on Memory configuration 2000 where a Boolean Processor 2010 is integrated within a memory module (RAM) 2020. In the configuration 2000, the Boolean Processor 2010 is realized in the same circuitry and/or logic as the RAM 2020. Generally, the RAM 2020 connects to a microprocessor 2030 through a memory bus 2040. A benefit of Chip on Memory configuration 2000 is that the microprocessor 2030 can process data much faster than it can read data from the memory 2020. Because of this, conventional solutions in the art include branch prediction architectures that enable a microprocessor to execute other operations while it waits for data from memory to complete prior computations. For example, in a branch prediction architecture, a microprocessor may process a computation in each of five possible outcomes and then move on to other operations in the microprogram while it waits for data to determine which of the five possible outcomes is valid. When it receives the data from memory, the microprocessor determines which of the five outcomes is correct and discards the results of the other four. All of this is done to keep the program running as fast as possible by minimizing the wait time of data from memory. Advantageously, the present invention provides an improvement over such solutions. Specifically, the present invention may include the Boolean Processor 2010 in the memory 2020 to supply qualified data to a microprocessor faster than the microprocessor can complete computations on it. The Chip on Memory configuration 2000 is an integrated circuit in a single package with the Boolean Processor 2010 and the RAM 2020 formed in the same circuit. The integrated circuit includes connections forming the memory bus 2040 to the microprocessor.

Through the present invention, latency in the random access memory 2020 and the indexing of large data sources (Terabytes of data per day) can be dramatically reduced using a Boolean Processor Switched Memory. The switching technology described herein can be used in both a stand-alone implementation and in conjunction with the Boolean Processor 2010. Switched memory solves the latency problem by bringing conventional RAM read and write response times up to the speed of microprocessors and microcontrollers. When used in conjunction with the Boolean Processor 2010, switched memory qualifies data at even faster rates, effectively increasing memory speeds by several orders of magnitude. It will also be shown that switched memory and the Boolean Processor 2010, which operate at peak speed in Asynchronous implementations, can offer significant increases in processing speeds while operating in a clocked environment.

In a Chip on Memory configuration 2000, one or more of the following features may be provided by the Boolean Processor 2010: a) Searching the memory 2020 for data that meets criteria specified in the Boolean Processor's 2010 instruction store; b) Dynamically updating the instruction store of the Boolean Processor 2010 to search the memory 2020 against any criteria; c) Marking data in memory 2020 that meets the search criteria; d) Incorporating the Boolean Processor 2010 as a component in the memory 2020 and using the Boolean Processor 2010 to accelerate data retrieval; e) Returning marked data to requesting hardware and/or software; and f) Manipulating marked data within the memory 2020.

Placing the Boolean Processor 2010 on chip with the memory 2020 will eliminate memory latency issues in computing systems. An asynchronous implementation of the Boolean Processor Switched Memory will theoretically operate at terahertz speed and vastly improve the rate at which relevant data is fed to a microprocessor or microcontroller. With the addition of direct memory access, Boolean Processor Enhanced Memories hold the promise of increasing RAM speeds by several orders of magnitude and shifting the burden of “catching up” to microprocessors and microcontrollers.

The Chip on Memory configuration 2000 may be implemented in synchronous (clocked) or asynchronous mode (clockless or self-clocking) and the Chip on Memory configuration 2000 may act as a co-processor to the microprocessor 2030. The microprocessor 2030 is configured, using internal software, to program and control the Boolean Processor 2010 and the microprocessor 2030 directs the Boolean Processor 2010 to deliver specific data from the memory 2020. Utilizing the criteria for the specific data, the Boolean Processor 2010 is configured to deliver qualified data to the microprocessor 2030.

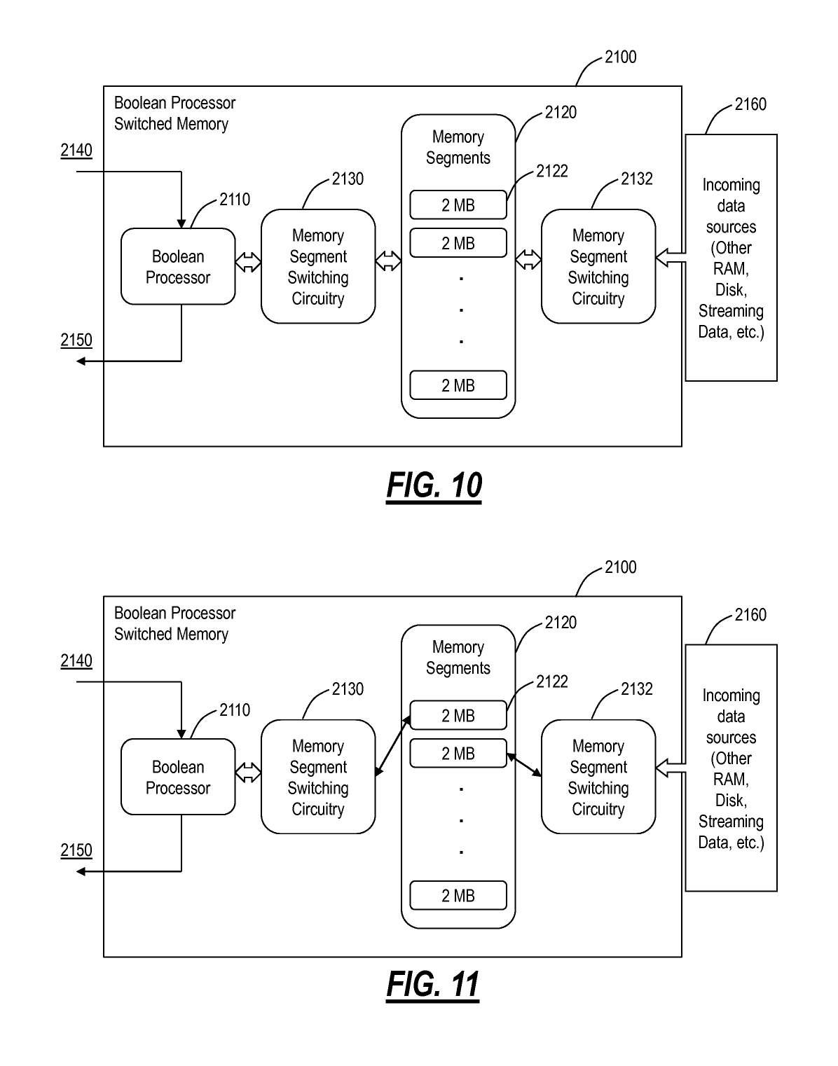

The Chip on Memory configuration 2000 may further include a memory switching architecture where the Boolean Processor 2010 is fed data and delivers qualified data. An exemplary memory switching architecture is illustrated in FIGS. 10-11. The memory switching architecture is configured to provide data to the Boolean Processor 2010 faster than the Boolean Processor 2010 can search it (meaning that the Boolean Processor 2010 is never waiting for data). The memory switching architecture is accomplished by segmenting the memory into a plurality of segments. For example, each memory segment is emptied by the Boolean Processor 2010 and filled from an incoming data source. The incoming data source can come from disc, streaming network data or any other streaming data or storage medium. For large Data Stores, many Chip on Memory configurations 2000 may be run in parallel (“n” chip on memory modules in a divide and conquer scheme). Further embodiments may include, but are not limited to, a Chip on Memory-centric solution in which computational co-processors are added to the system.

In one aspect, the present invention brings a chip to memory as an alternative to bringing more memory (i.e., cache) to a chip. While this approach is not practical for most computing architectures (because of their size and complexity), the Boolean Processor 2010 is a viable option in this computing space. Note, the present invention contemplates any configuration of the Boolean Processor 2010, such as, for example, the Boolean Processors described in FIGS. 1-8 and in U.S. patent application Ser. No. 12/033,644 filed on Feb. 19, 2008 and entitled “BOOLEAN PROCESSOR” and in U.S. patent application Ser. No. 12/364,047 filed on Feb. 2, 2009 and entitled “ENHANCED BOOLEAN PROCESSOR.” As shown below in the bottom row of Table 1, the Boolean Processor has a small enough footprint to be included on chip with main memory.

TABLE 1
Boolean Processor Specifications (with 1,000 instruction Control Store)

| | | | | | | | |
|---|---|---|---|---|---|---|---|
| Address Size (bits) = n | 4 | 8 | 16 | 32 | 64 | 128 | 256 |
| Control/State Size | 4 | 8 | 16 | 32 | 64 | 128 | 256 |
| (bits) = m | | | | | | | |
| PC Word Size = | 11 | 19 | 35 | 67 | 131 | 259 | 515 |
| n + m + 3 | | | | | | | |
| Theoretical Clock | 10.07 | 9.28 | 8.02 | 6.32 | 4.43 | 2.77 | 1.59 |
| Speed (THz) | | | | | | | |
| MOPS | 1.01E+07 | 9.28E+06 | 8.02E+06 | 6.32E+06 | 4.43E+06 | 2.77E+06 | 1.59E+06 |
| Total Gate Count | 21,190 | 29,888 | 47,284 | 82,076 | 151,660 | 290,828 | 569,164 |

In addition, the inherent speed of the Boolean Processor 2010 permits faster searching through larger sets of data. However, it should be noted that the Boolean Processor 2010 is not intended to be a replacement for microprocessors 2030. It is intended to improve overall system processing power by bringing relevant data to a microprocessor 2030, leaving the microprocessor 2030 to perform complex computations and manipulations on the data.

Computing operations often include qualifying data and performing operations on, or manipulating, the qualified data. As an example, suppose that a system must find a subset of data within a 32 GB block of memory. Qualifying the data could include some Boolean expression (whether simple or complex) such as A=x and B=z and C=y, etc. For this example, we will assume that 50% of the data is qualified and subsequently manipulated in some fashion.

TABLE 2
Performance Benefit of “Chip on Memory”

| | 3.2 GHz | 64-bit Boolean |
|---|---|---|
| | Processor- | Processor on Chip |
| | 64 bit | with main memory |
| Speed (GHz) | 3.2 | 4430 (4.43 THz) |
| Operations per second | 3.2 × 10⁹ | 4.43 × 10¹² |
| Data Returned to microprocessor | 32 GB | 0 GB |
| before qualification | | |
| Time to Qualify Data | 10 sec. | 0.0072 sec. |
| Data Returned to microprocessor | 0 GB | 16 GB |
| after qualification | | |

As shown in Table 2, above, a standalone microprocessor must process all 32 GB of data prior to performing post-qualification operations. In a Chip on Memory scenario (right column), the Boolean Processor is capable of qualifying data at a much faster rate than the standalone microprocessor. This means that a Chip on Memory solution frees up bus space, opening the possibility for completely filling the memory bus with relevant data and delivering that data to a microprocessor faster than it can process it, thereby eliminating data latency. The Boolean Processor 2010 is capable of qualifying data at a much faster rate than the conventional microprocessor, leaving the microprocessor 2030 free to perform more complex operations. In addition, having memory 2020 that pre-qualifies data frees up bus space 2040, opening the possibility for delivering higher volumes of relevant data to microprocessors 2030. In additional to the “Chip on Memory” performance detailed above, the Boolean Processor 2010 has been quantified to run at theoretical processing speeds of up to 35 Terahertz (8-bit implementation).

While the theoretical speeds of the Chip on Memory solution are in the terahertz range (based on the technology's very short data path, current chip geometry, and the maximum theoretical speed of electricity), transistor technology is not currently capable of performing at these levels. Whether or not transistors get to terahertz speed is irrelevant. While chip speed has an impact on performance, the overriding factor contributing to data latency is the sparseness of the data. Therefore, regardless of the operating speed of Chip on Memory, data latency will be eliminated, as described below. Using the example described above in Table 2, a microprocessor without Chip on Memory would need to qualify all 32 GB of data prior to performing computations on it. Therefore, the memory bus would carry all 32 GB of the data to the microprocessor. In this case, only half of the data traveling across the bus 2040 to the microprocessor 2030 from the RAM 2020 is usable, as shown in FIG. 9a.

In a worst-case scenario, adding Chip on Memory to the solution running at the same speed as the microprocessor (3.2 GHz), all 32 GB of data is processed in the same amount of time. The difference is that only 16 GB of data travels across the memory bus 2040. Under this scenario, Chip on Memory has effectively doubled the throughput of the bus 2040. As a result, the memory can be doubled (to 64 GB) to deliver twice the volume of usable data (32 GB) across the bus 2040 in the same time period, as shown in FIG. 9b. Again, this example is a worst-case scenario. In many processing problems, such as data indexing and genome processing, the data is very sparse. This degree of sparseness has a direct effect on the effectiveness of the Chip on Memory solution: the more sparse the data, the better the throughput. For example, if a large amount of data is being processed and 10% of it is considered usable, only 10% of the memory bus is transporting usable data. Without Chip on Memory, microprocessors have to qualify all of the data to get to the usable 10% prior to performing any additional operations on it. Using Chip on Memory, the memory that is paired with a microprocessor can be scaled up by a factor of 10 and deliver 100% usable data across the memory bus, thereby increasing the effective throughput of the bus by an equal factor of 10. In addition, only a fraction of the original number of microprocessors would be needed with Chip on Memory since the job of qualifying data is no longer that of the microprocessor. In application, the Chip on Memory solution should execute at much faster speeds than its microprocessor counterparts in both clocked and asynchronous implementations. This is due to the very short data paths and small electrical footprints of both the Boolean Processor and the Switched Memory portions of the Chip on Memory solution. While clocking these circuits should produce speeds in the high gigahertz range, asynchronous implementations should yield even higher speeds.

The Boolean Processor 2010 in the Chip on Memory configuration 2000 application helps satisfy the problem of memory 2020 keeping up with processor speeds by taking Boolean intensive busy work away from the microprocessor 2020 and “feeding” it exclusively with higher concentrations of computationally intensive data for which they are best suited. Data qualification, coupled with the speed of the Boolean Processor 2010 solves the dilemma of “feeding the microprocessor beast”. The present invention addresses those considerations by describing an asynchronous implementation of the Boolean Processor 2010 and a memory switching technique. The former enables the Boolean Processor 2010 to run without the burden of a clock, while the latter enables the Boolean Processor 2010 to address large scale memory while maintaining its processing speed.

Thus, in an exemplary embodiment, the present invention provides an Asynchronous Boolean Processor. Asynchronous, or clock-less, chip designs are not new. Manufacturers have begun to release asynchronous microprocessor cores (such as the ARM996HS1 available from ARM, Inc.) into production over the past few years. However, the release of this type of circuitry has been limited due to design difficulty. Asynchronous circuitry has proven difficult to design due to a lack of asynchronous design tools. Most circuit design tools are built around synchronous design principles. In addition, the verification of asynchronous designs adds a high degree of cost and complexity to their commercialization, as described by Paul Alexander Cunningham in “Verification of Asynchronous Circuits.” University of Cambridge, Technical Report Number 587 April 2004: 2:

“To verify that a circuit is correct its intended behaviour must first be articulated in some unambiguous way, referred to as a specification. Once a specification has been made a well-defined procedure can then be executed to determine whether that circuit conforms to its specification. When the specification and the conformance checker have a formal foundation, verification is akin to a mathematical proof that the circuit will always behave as intended. Such a proof is in contrast to simulation where it is merely demonstrated that a circuit responds in a certain way to a specific set of input stimuli. Unfortunately, formal verification is both computationally complex and its formal foundation unnatural for many hardware engineers. Consequently, the commercial cost of formal verification is often high, making its use uncommon when compared to simulation.”

In theory, asynchronous circuitry should run many times faster than synchronous (clocked) circuits, since they are self-timing. However, because of the limited tools and difficulty in verifying these circuits, the industry has focused on “low hanging fruit” that encompasses small, embedded, low power asynchronous designs. For example, the ARM996HS contains just under 90,000 gates and consumes 0.045 mW/MHz. This low power implementation comes at a cost, resulting in an equivalent synchronous speed of 77 MHz. With a market that includes pagers, network transceivers, and cordless handsets, there is no compelling need to push this circuitry to a higher level of performance. The ARM996HS utilizes a handshaking protocol scheme to run asynchronously. This can introduce delay circuitry into the design, resulting in significant reductions in speed.

An asynchronous implementation of the Boolean Processor 2010 has the capability to overcome the problems listed above due to its simplicity. This very small footprint will yield a much higher percentage of verification success. In addition, the simplicity of the architecture lends itself to a delay insensitive design, in which the asynchronous operation of the chip does not rely on the delay in any gate, wire, or other circuitry. A synchronous version of the Boolean Processor 2010, running at the same speed as the microprocessor 2030, will also provide latency free qualified data to the microprocessor 2030. Faster synchronous and asynchronous versions will shift the burden of latency to the microprocessor 2030 and away from the memory 2020. In addition, when this technology is used in Data Indexing applications, the additional speed of an asynchronous design will be optimal when searching terabytes of data. Such an example is the Large Hadron Collider at CERN, in which an Internet's worth of data is generated on a daily basis.

Accordingly, the present invention provides a method of “Feeding the Beast” via Memory Switching. The fastest memory chips today can operate with a 3 ns response time, which corresponds to a speed of 333 MHz. At 4.43 THz, a 64-bit implementation of the Boolean Processor can theoretically process data at a rate that is 10,660 times faster than the fastest memory can supply data. This disparity in speed is directly related to size of each circuit. In a 64-bit implementation, the Boolean Processor 2010 contains just over 151,000 gates (including a 1,000 instruction control store). In contrast, large RAM chips (1 GB and above) utilize one to six gates per bit of memory, depending upon the technology used. As a result, the data paths for large RAM chips are significantly longer than the data path for the Boolean Processor 2010. In the Chip on Memory configuration 2000, a single Boolean Processor 2010 can be switched among multiple segments of homogenous memory. Utilizing small enough memory segments (approximately 2 MB each), the speed of the memory can be scaled to match the speed of the Boolean Processor 2010.

For example, the Boolean Processor may be implemented in any custom made or commercially available processor, a central processing unit (CPU), an auxiliary processor among several processors associated with a computer, a semiconductor-based microprocessor (in the form of a microchip or chip set), special purpose logic devices (e.g., application specific integrated circuits (ASICs)) or configurable logic devices (e.g., simple programmable logic devices (SPLDs), complex programmable logic devices (CPLDs), field programmable gate arrays (FPGAs)), or generally any device for executing instructions.

Referring to FIG. 10, in an exemplary embodiment, a 2 GB Boolean Processor Switched Memory chip 2100 is illustrated for realizing the Chip on Memory configuration 2000. The Memory chip 2100 includes a single 64-bit Boolean Processor Core 2110 with a 1K control store, approximately 1,000 memory segments 2120 each including 2 MB of RAM 2122 per segment, circuitry 2130, 2132 for memory segment switching, and associated input/output paths 2140, 2150, 2160. FIG. 10 illustrates a functional block diagram of the above components. The circuitry 2130, 2132 is configured to permit the switching of (i) The Boolean Processor Core 2110 among the 1,000 memory segments 2120 and (ii) Incoming data sources 2160 (such as streaming data, data from disk, and data from outside memory sources) among the 1,000 memory segments 2120. The Boolean Processor Core 2110 is configured to receive instructions 2140 from a host system and to send qualified data 2150 to the host system. The host system may include a microprocessor connected to the Memory chip 2100.

The memory segment switching circuitry 2130, connects the Boolean Processor Core 2110 to a single 2 MB segment 2122 of memory at any given point in time. Upon completing the processing of the data within the single 2 MB segment 2122, the Boolean Processor Core 2110 will trigger an output to the switching circuitry 2130 (via a new, dedicated instruction to handle the operation). This output will increment a Segment Address Register within the switching circuitry 2130 that directs the Boolean Processor Core 2110 to the memory segment 2122 that is identified by the value in the register. Similarly, the memory segment switching circuitry 2132 is used to facilitate the filling of the memory segments 2120 in a circular manner. At any given time, the Boolean Processor Core 2110 is qualifying data within a single memory segment 2122, while another segment 2122 is being overwritten with new data, as shown in FIG. 11. The Segment Address Register in this portion of the circuit will be incremented via circuitry in each memory segment 2122 that will send a trigger signal when its last address has been overwritten. Memory segments 2122 that are not being accessed by the Boolean Processor Core 2110 (at any point in time) effectively act as a buffer for incoming data.

As shown below in Table 3, all of the switching circuitry will occupy only a few thousand gates. Combined with the gate count for a 64-bit Boolean Processor (151,000 gates, including a 1K control store), the circuitry required to interface a Boolean Processor on-chip with RAM is less than one tenth of one percent of the total gates required to implement a conventional 2 GB RAM memory chip. The “Switching Lines” are the number of wires required to address the segments of memory.

TABLE 3
Boolean Processor Switched Memory Speed and Gate Calculations

| | | | |
|---|---|---|---|
| Switching Lines | 10 | 11 | 12 |
| Number of Addressable Memory Segments | 1,024 | 2,048 | 4,096 |
| Memory Segment Size (MB) | 2 | 2 | 2 |
| Total Possible RAM size (GB) | 2 | 4 | 8 |
| Data Path Length by Component | | | |
| Adder | 62 | 67 | 72 |
| Segment Address Register | 9 | 9 | 9 |
| Segment Selector Logic | 30 | 33 | 36 |
| Memory Segment (y = size in Bytes) | 1024000 | 1024000 | 1024000 |
| Chip Geometry (m) | 4.5E−08 | 4.5E−08 | 4.5E−08 |
| Path Length in Gates | 1024101 | 1024109 | 1024117 |
| Total Data Path Length (m) | 4.61E−02 | 4.61E−02 | 4.61E−02 |
| Cycle Time (sec.) | 1.54E−10 | 1.54E−10 | 1.54E−10 |
| Cycles/Second | 6.49E+09 | 6.49E+09 | 6.49E+09 |
| Clock Speed (GHz) | 6.49 | 6.49 | 6.49 |
| Operations per Second | 6.49E+09 | 6.49E+09 | 6.49E+09 |
| MOPS | 6.49E+03 | 6.49E+03 | 6.49E+03 |
| Total Gates for all Switching Circuitry | 3,445 | 12,735 | 49,673 |

The 2 MB segment 2122 example described above is used to a show the simplicity of the switching circuitry when used with a 64-bit Boolean Processor operating at speeds in the GHz range. In this case, the 2 MB segments 2122 were chosen because the speed of the circuitry outpaces the speed of a 3.2 GHz Boolean Processor Core 2110. Other embodiments may use faster or slower Boolean Processor Core 2110 implementations (ex: 32-bit, 128-bit) and will be designed with memory segments 2122 that are sized to most closely match the speed of the processing circuitry. For example, a 128-bit Boolean Processor can theoretically run at 2.77 THz. In this case, a memory segment size of 4 KB will yield a speed of 3 THz for the switching and memory circuitry which is adequate to outpace the Boolean Processor Core.

The addition of direct memory access to the Boolean Processor Switched Memory chip 2100 will combine its data qualification behavior with the read and write capabilities of a conventional RAM circuit. Direct memory access is achieved through direct manipulation of the Segment Address Register in the switching circuitry 2130, 2132 described above. Two additional registers would also be employed in this scenario: an offset register for indicating the starting address within a segment of memory and a counter for maintaining read and write block sizes. Each of these registers will be maintained by the Boolean Processor Core 2110.

While the ideal implementation of the Boolean Processor Core 2110 and Boolean Processor Switched Memory chip 2100 is with asynchronous (clockless) circuitry, both may be implemented with clocking circuitry. While clocking the circuitry of the Boolean Processor Switched Memory 2100 will not produce the terahertz speed that it is capable of reaching, it will permit the memory 2120 to meet, or exceed, the speed of mainstream microprocessors and microcontrollers, thus eliminating data latency.

The Boolean Processor Switched Memory architecture offers the following enhancements to microprocessor performance: (a) An increase in processing speed due to the elimination of data latency; (b) A further increase in processing speed based on the elimination of unqualified (noisy) data; (c) A smaller microprocessor footprint due to the elimination of gates used for qualifying data; and (d) less power required by the microprocessor due to fewer gates (because of less required functionality).

The Boolean Processor Switched Memory (BPSM) solution can be used to index data at very high speeds. The amount of data indexed per unit of time is theoretically infinite because the architecture is infinitely scalable. Practically speaking, many Boolean Processor Switched Memories can be combined in parallel and, as a result of the small footprint, placed on a single chip. This design can achieve a massively parallel search engine that is economically viable. For very large search applications, many of these massively parallel chips can be combined to form a self-contained search appliance. This appliance will be capable of searching large data stores in parallel using the same algorithm or a combination of different algorithms. In either case, the cost of searches using this approach should be low enough to permit this search capability to be built into mainstream computer designs.

It is envisioned that a Chip on Memory solution will be dynamically programmed by a host microprocessor with which it is paired. The microprocessor will program the Boolean Processor to retrieve data that matches the search criteria of one or more algorithms. While the Chip on Memory solution has its own instruction set, it is expected that compilers will handle any instruction changes required to take advantage of the processing benefits. Once recompiled, existing application software will be able to utilize Chip on Memory.

In another exemplary embodiment, Boolean Processor/Switched Memories may be cascaded into a layered and/or networked structure to permit multiple Boolean Processor/Switched Memories to work together in “divide and conquer” scenarios whereby searches are broken into smaller parts and divided among the memory units. This scheme may also be useful in Artificial Intelligence applications that use adaptive memories for the purpose of machine learning.

Several other embodiments of the memory switching techniques may also be implemented and include, but are not limited to: a Boolean Processor/Switched Memory that utilizes a very small number of segments (Ex: four segments) such that the entire memory unit acts as a filter for streaming data; a Boolean Processor enhanced memory that utilizes multiple Boolean Processors within the same memory chip (i.e. “Chips on Memory”) to further drive the performance of the memory; and an enhanced memory circuit that utilizes another form of processor or circuitry for accessing data using the direct memory access and switching circuitry described herein. Yet another embodiment is the implementation of the switching circuitry described herein to manipulate cache memory in microprocessors.

Advantageously, the Chip on Memory configuration 2000 solution can have a dramatic impact on many data intensive applications that exist today. Current computer architectures are mathematically and computationally centric. These architectures were developed from roots in processing complex mathematical computations and solving engineering problems. Newer applications, such as genome processing and the indexing of Internet data have spawned an explosion of data that is becoming increasingly difficult to organize and manage. As meaningful data continues to be dwarfed by irrelevant data, memory hierarchies in current architectures lose their effectiveness and microprocessors are increasingly forced to fetch data from slower sources such as RAM or disk. While mathematically and computationally intensive operations are still an essential part of computing, this new data-intensive paradigm requires that computers find relevant data before they can process it. Mainstream computing companies have solved this problem by scaling computer systems horizontally, creating huge server farms and data centers. That solution works, but it comes at an enormous financial cost in terms of hardware, energy, real estate, and labor. In contrast, the Chip on Memory configuration 2000 solution is data centric and offers the following benefits: A significant increase in processing speed due to the elimination of data latency; a further increase in processing speed based on the elimination of unqualified (noisy) data; an increase in memory bus throughput that is inversely proportional to the sparseness of the data being processed; a reduction in microprocessor footprints due to the elimination of gates used for caching and qualifying data; the elimination of large numbers of microprocessors in computing solutions (due to the efficient elimination of noisy data); and significant processing improvements (orders of magnitude faster) in large scale data indexing applications.

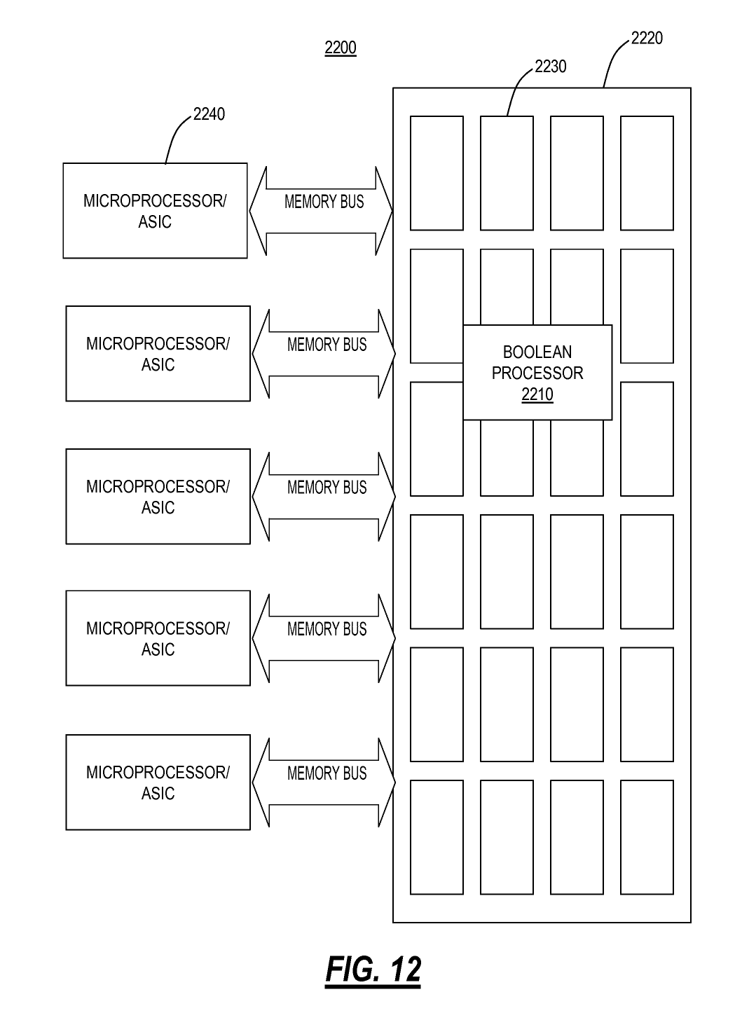

Referring to FIG. 12, in an exemplary embodiment, a block diagram illustrates a configuration 2200 where a Boolean Processor 2210 is integrated within a memory module (RAM) 2220 with many large blocks of RAM 2230. In the configuration 2200, the module 2220 is a Boolean Processor Switched Memory in which a single Boolean Processor 2210, or other type of processor, is utilized in the Chip on Memory configuration 2000 with the many large blocks of RAM 2230 as the central component of a computing architecture. In this paradigm, specialized microprocessors and/or application specific integrated circuits (ASICs) 2240 would be used to handle mathematically intensive computations or other computations not handled by the Boolean Processor 2210. Here, the Boolean Processor 2210 is the dominant component in computing architectures with the microprocessors, microcontrollers, etc. becoming secondary, specialized processing units.

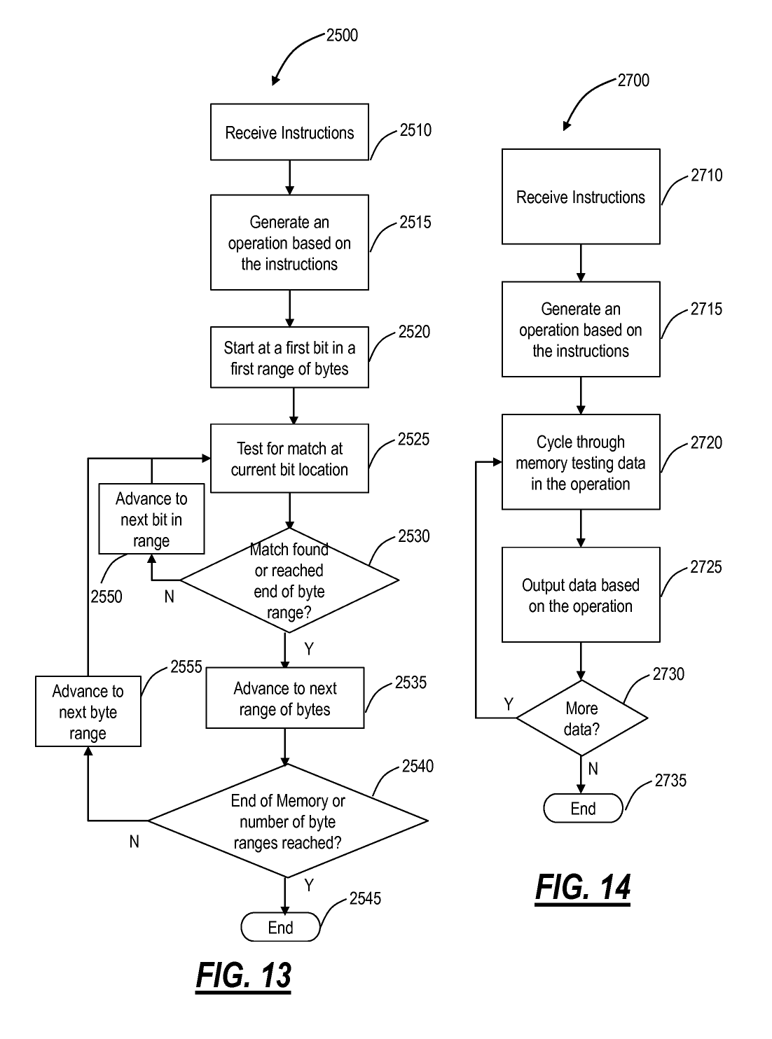

Referring to FIG. 13, in an exemplary embodiment, a flowchart illustrates a method 2500 of matching sub-bytes utilizing exemplary embodiments of the present invention. Specifically, the method 2500 may be implemented via circuitry and corresponding instructions to the Chip on Memory configuration 2000 and/or the Boolean Processor Switched Memory chip 2100. The method 2500 begins with receiving instructions (step 2510). For example, the instructions may be from a microprocessor instructing the Chip on Memory configuration 2000 and/or the Boolean Processor Switched Memory chip 2100 to conduct a search through memory for a specified value. The functionality will permit a search of any value contained within “n” bits to commence at the first bit of a byte. An operation is generated based on these instructions (step 2515). For example, the operation may include a Boolean test for searching the memory for a specified value with the test being performed by a Boolean Processor or the like. The method 2500 may include two loops—one for the bit-wise looping within one or more bytes and the other for looping though all of the bytes in memory. The method 2500 starts searching at a first bit in a first range of bytes (step 2520). The method 2500 tests for a match at a current bit location (step 2525). If a match is found or an end of the range of bytes is reached (step 2530), the method 2500 advances to a next range of bytes (step 2535). If this next range is the end of memory or a specific number of bytes (step 2540), then the method 2500 ends (step 2545). At step 2530, if a match is not found and not at the end of the range of bytes (step 2530), the method 2500 advances to the next bit in the range (step 2550) and returns to step 2525. At step 2540, if the end of memory is not reached and the specific number of byte ranges is not reached (step 2540), then the method 2500 advances to the next byte range (step 2555) and returns to step 2525.

Referring to FIG. 14, in an exemplary embodiment, a flowchart illustrates a method 2700 for repetitively matching the contents of one or more bytes and/or portions of bytes utilizing exemplary embodiments of the present invention. Specifically, the method 2700 may be implemented via circuitry and corresponding instructions to the Chip on Memory configuration 2000 and/or the Boolean Processor Switched Memory chip 2100. The method 2700 begins with receiving instructions (step 2710). For example, the instructions may be from a microprocessor instructing the Chip on Memory configuration 2000 and/or the Boolean Processor Switched Memory chip 2100 to conduct a search through memory for a specified value. It is envisioned that blocks of “x” bytes will be uniformly distributed throughout a larger memory and these blocks will be tested against some form of Boolean criteria. An operation is generated based on these instructions (step 2715). The method 2700 cycles through the memory testing data in the operation (step 2720). If matches are discovered, then the blocks of “x” bytes are output to the host system (step 2725). The method continues (step 2730) if there is more data to search, and ends (step 2735) after cycling through all of the data in the memory. In order to support this functionality, the Chip on Memory configuration 2000 will use three additional registers: an offset register for maintaining the size of “x” bytes, a memory start register for storing the starting address of the first of the “x” bytes, and an offset countdown or offset increment register for iterating through the “x” bytes. In addition the Chip on Memory configuration 2000 will contain instructions and circuitry for manipulating these registers including, but not limited to, a “Set Memory Offset” instruction and a “Set Memory Start” instruction. The former instruction will set the value of the offset register and the latter instruction will set the value of the memory start register. The combination of the aforementioned registers and instructions will also be used to output blocks of “x” bytes whenever a match has been determined, wherein a match is determined to be the positive result of a prescribed Boolean operation.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. An integrated circuit forming a memory module connected to a microprocessor, comprising:
a plurality of memory segments configured to store data;
a Boolean Processor unit in communication with the plurality of memory segments; and
a plurality of input/output interfaces in communication with the plurality of memory segments, the Boolean Processor, and the microprocessor;
wherein the Boolean Processor unit is configured to qualify data for the microprocessor from the plurality of memory segments responsive to the instructions.

2. The integrated circuit of claim 1, wherein the Boolean Processor unit comprises:
a Boolean logic unit, wherein the Boolean logic unit is operated for performing the short-circuit evaluation of a Normal Form Boolean expression/operation;
a second plurality of input/output interfaces in communication with the Boolean logic unit, wherein the second plurality of input/output interfaces are operated for receiving a plurality of compiled Boolean expressions/operations and transmitting a plurality of compiled results; and
a plurality of registers coupled to the second plurality of input/output interface circuits, wherein the plurality of multi-bit registers comprise an instruction register, a first address register and a second address register.

3. The integrated circuit of claim 1, wherein the integrated circuit is implemented in an asynchronous mode as one of clockless or self-clocking.

4. The integrated circuit of claim 1, further comprising:
a memory switching architecture comprising memory segment switching circuitry, wherein the memory segment switching circuitry is in communication with the plurality of input/output interfaces, the plurality of memory segments, and the Boolean Processor unit.

5. The integrated circuit of claim 4, wherein the memory segment switching circuitry is configured to:
connect the Boolean Processor unit to a first segment of the plurality of memory segments at any given point in time;
switch the Boolean Processor unit to a second segment of the plurality of memory segments responsive to a trigger from the Boolean Processor unit; and
connect a third segment of the plurality of memory segments to the plurality of input/output interfaces for buffering incoming data.

6. The integrated circuit of claim 5, further comprising:
a first segment address register in the memory segment switching circuitry being indicative of one of the plurality of memory segments to connect to the Boolean Processor unit; and
a second segment address register in the memory segment switching circuitry being indicative of one of the plurality of memory segments to connect to the plurality of input/output interfaces.

7. The integrated circuit of claim 6, wherein the Boolean Processor unit comprises:
an offset register for indicating a starting address within one of the plurality of memory segments; and
a counter for maintaining read and write block sizes.

8. The integrated circuit of claim 1, wherein the Boolean Processor unit comprises an n-bit processor, wherein each of the memory segments comprises m bytes, and wherein the plurality of memory segments comprises a total of x bytes, n, m, and x comprise an integer.

9. The integrated circuit of claim 1, wherein a size of the Boolean Processor unit is selected to closely match a speed of the integrated circuitry.

10. The integrated circuit of claim 1, wherein the integrated circuitry operates in excess of 1 THz speed in qualifying data in the plurality of memory segments utilizing the Boolean Processor unit.

11. The integrated circuit of claim 1, further comprising:
an algorithm operable through the Boolean Processor unit for matching sub-bytes in the plurality of memory segments, wherein the algorithm provides a search of any value contained with n bits in the plurality of memory segments.

12. The integrated circuit of claim 1, further comprising:
an algorithm operable through the Boolean Processor unit for repetitively matching contents of one or more bytes in the plurality of memory segments, wherein each match is output to the plurality of input/output interfaces, and wherein the algorithm is configured to cycle through each of the plurality of memory segments.

13. A Boolean Processor Switched Memory, comprising:
a Boolean Processor receiving instructions from an external device and sending data to the external device based on the instructions;
a plurality of memory segments; and
memory segment switching circuitry connected to the Boolean Processor and the plurality of memory segments;
wherein the Boolean Processor is configured to receive instructions from the external device and transmit data based on the instructions from the plurality of memory segments.

14. The Boolean Processor Switched Memory of claim 13, wherein the memory segment switching circuitry is configured to:
connect the Boolean Processor to a first segment of the plurality of memory segments at any given point in time;
switch the Boolean Processor to a second segment of the plurality of memory segments responsive to a trigger from the Boolean Processor; and
connect a third segment of the plurality of memory segments to an incoming data source for buffering incoming data.

15. The Boolean Processor Switched Memory of claim 14, further comprising:
a first segment address register in the memory segment switching circuitry being indicative of one of the plurality of memory segments to connect to the Boolean unit; and
a second segment address register in the memory segment switching circuitry being indicative of one of the plurality of memory segments to connect to the incoming data source.

16. The Boolean Processor Switched Memory of claim 15, wherein the Boolean Processor comprises:
a Boolean logic unit, wherein the Boolean logic unit is operated for performing the short-circuit evaluation of a Normal Form Boolean expression/operation;
a plurality of input/output interfaces in communication with the Boolean logic unit, wherein the plurality of input/output interfaces are operated for receiving a plurality of compiled Boolean expressions/operations and transmitting a plurality of compiled results; and
a plurality of registers coupled to the plurality of input/output interface circuits, wherein the plurality of multi-bit registers comprise an instruction register, a first address register, a second address register, and an offset register for indicating a starting address within one of the plurality of memory segments; and
a counter for maintaining read and write block sizes.

17. The Boolean Processor Switched Memory of claim 13, further comprising:
an algorithm operable through the Boolean Processor for matching sub-bytes in the plurality of memory segments, wherein the algorithm provides a search of any value contained with n bits in the plurality of memory segments.

18. The Boolean Processor Switched Memory of claim 13, further comprising:
an algorithm operable through the Boolean Processor for repetitively matching contents of one or more bytes in the plurality of memory segments, wherein each match is output to the external device, and wherein the algorithm is configured to cycle through each of the plurality of memory segments.

19. A method, comprising:
at a memory module comprising an integrated Boolean Processor, receiving an instruction related to qualifying data in the memory module;
generating a Boolean operation based on the instruction;
evaluating the Boolean operation on data in the memory module; and
providing qualified data based on the evaluation to an external device from the memory module.

20. The method of claim 19, wherein generating and evaluating the Boolean operation comprises:
receiving a Normal Form Boolean expression, wherein the Normal Form Boolean expression comprises a conjunct or a disjunct;
evaluating the conjunct or disjunct;
selectively short-circuiting a portion of the Normal Form Boolean expression; and
outputting a result of the Normal Form Boolean expression.
